(19) United States
(12) Patent Application Publication
(10) Pub. No.: US 2011/0106753 A1
(43) Pub. Date: May 5, 2011

(54) DOCUMENT MANAGING SYSTEM

(75) Inventors: Yusuke Hamada, Shizuoka-ken (JP); Kazuhiro Ogura, Kanagawa-ken (JP); Shinji Makishima, Shizuoka-ken (JP); Akihiro Mizutani, Tokyo-to (JP); Toshihiro Ida, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/914,169

(22) Filed: Oct. 28, 2010

Related U.S. Application Data
(60) Provisional application No. 61/256,523, filed on Oct. 30, 2009.

(51) Int. Cl. G06F 17/30

(52) U.S. Cl. 707/608; 707/E17.008

(57) ABSTRACT

According to one embodiment, a document managing system includes a communication unit, a printing unit, a reading unit, a document-management-information storing unit, a discarding-information storing unit, an informing unit, and a management-information analyzing unit. The reading unit reads a document recorded on a recording medium and acquires a document file. The document-management-information storing unit stores, together with the document file, document management information including a confidentiality level of the document. The discarding-information storing unit stores plural kinds of discarding information for discarding a plurality of the recording media each of which is different depending on the confidentiality level of the document. The management-information analyzing unit acquires the discarding information corresponding to the confidentiality level of the document read by the reading unit and informing the discarding information from the informing unit.

### CROSS-REFERENCE TO RELATED APPLICATIONS

This application is based upon and claims the benefit of priority from: U.S. provisional application 61/256,523, filed on Oct. 30, 2009, the entire contents of each of which are incorporated herein by reference.

### FIELD

Embodiments described herein relate generally to a document managing system that enables discarding of a recording medium with a discarding method corresponding to a confidentiality level of a document recorded on the recording medium.

### BACKGROUND

In recent years, in order to realize prevention of leakage of secrets, it is attempted to improve security for a recording medium such as a sheet on which a document is recorded (hereinafter referred to as printed document). Companies employ a system for authenticating, with an objective scale, a degree of measures taken for security such as ISMS (Information Security Management System) authentication. A confidentiality level of the printed document is managed by the ISMS authentication or the like. For automatic discarding of the printed document, information including information concerning the confidentiality level, for example, an IC tag is embedded in the printed document and the printed document is discarded by a method corresponding to significance or the confidentiality level of the document stored in the IC tag.

### BRIEF DESCRIPTION OF THE DRAWINGS

FIG. 1 is an overall diagram of a digital multifunction peripheral to which a document managing system according to a first embodiment is applied;

FIG. 2 is a diagram for explaining confidential information including information concerning a confidentiality level of a printed document;

FIG. 3 is a functional block diagram of the digital multifunction peripheral;

FIG. 4 is a schematic diagram of an example of document management information;

FIG. 5 is a schematic diagram of an example of document discarding information for discarding a printed document stored in a discarding information management database;

FIG. 6 is a printing operation flowchart;

FIG. 7 is a discarding operation flowchart;

FIG. 8 is a diagram of an example of a discarding registration screen for registering a printed document requested to be discarded;

FIG. 9 is a diagram of an example of a registration confirmation screen;

FIG. 10 is a diagram of an example of the discarding registration screen displayed on a display unit;

FIG. 11 is a functional block diagram of a modification of the digital multifunction peripheral; and

FIG. 12 is a discarding operation flowchart.

### DETAILED DESCRIPTION

In general, according to one embodiment, a document managing system includes a communication unit, a printing unit, a reading unit, a document-management-information storing unit, a discarding-information storing unit, an informing unit, and a management-information analyzing unit. The communication unit receives, together with a document file obtained by forming a document as a file, document management information including a confidentiality level of the document. The printing unit adds information indicating the confidentiality level to the document file and records the information on a recording medium. The reading unit reads the document recorded on the recording medium. The document-management-information storing unit stores, together with the document file, the document management information including the confidentiality level of the document. The discarding-information storing unit stores plural kinds of discarding information for discarding a plurality of the recording media each of which is different depending on the confidentiality level of the document. The management-information analyzing unit acquires the discarding information corresponding to the confidentiality level of the document read by the reading unit and informing the discarding information from the informing unit.

A first embodiment is explained below with reference to the drawings.

FIG. 1 is an overall diagram of a document management system applied to a digital multifunction peripheral (hereinafter referred to as MFP) 1. The MFP 1 performs, for example, printing of a document on a recording medium 2, copying of the recording medium 2 having the document recorded thereon, and printing of image data or the like transmitted from the outside on the recording medium 2. The recording medium 2 such as a sheet having a document recorded thereon in the same manner as above is a printed document 2a.

Plural computers, for example, two personal computers (PCs) 3-1 and 3-2 are connected to the MFP 1 via a network. Each of the PCs 3-1 and 3-2 operates according to operation by a user. A paper document management database 4 as a document-management-information storing unit and a discarding-information-by-confidentiality-level management database (hereinafter abbreviated as discarding information management database) 5 as a discarding-information storing unit are connected to the MFP 1. The MFP 1 can read information from and write information in the paper document management database 4 and the discarding information management database 5. A discarding unit 6 is connected to the MFP 1. The discarding information 6 discards the recording medium 2 having the document recorded thereon.

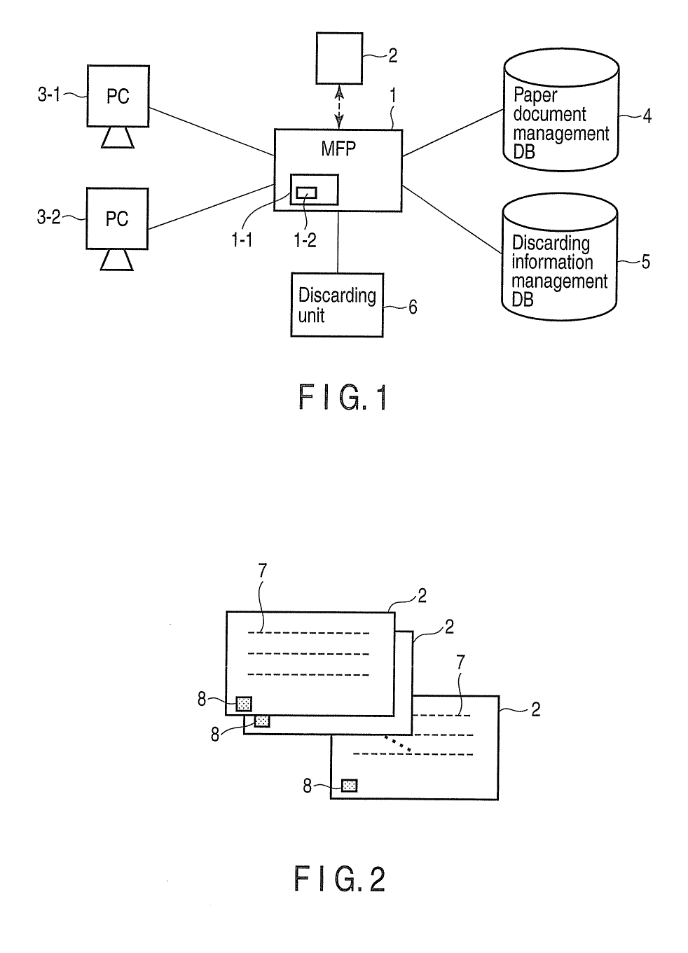

As shown in FIG. 2, the MFP 1 performs printing of a document 7 on recording media 2. The MFP 1 grants management information 8 including confidentiality levels to the documents 7 and prints the management information 8. The management information 8 includes information concerning confidentiality levels of the documents 7 printed on the recording media 2. The management information 8 includes data codes such as a QR code, an IC code, or a barcode. The management information 8 may be granted to the documents 7 by embedding IC tags in the recording media 2. The management information 8 includes document names, user names, and the numbers of pages of documents. The management information 8 includes plural confidentiality levels different for the respective recording media 2. The plural confidentiality levels are set as, for example, confidentiality levels “L1”, “L2”, . . . , and “LG” according to low to high confidentiality levels. The management information 8 is set according to the confidentiality levels “L1”, “L2”, . . . , and “LG” of the documents 7.

The MFP 1 is mounted with a controller 1-1 including a not-shown processor. The controller 1-1 executes a document file discarding program stored in a program memory 1-2. The document file discarding program causes a reading unit 10 to read the printed document 2a and acquire a document file, stores the management information 8 including the confidentiality level “L1”, “L2”, . . . , or “LG” of the document in the paper document management database 4 together with the document file, stores plural kinds of discarding information 101-1, 101-2, . . . , or 101-n for discarding the printed documents 2a each of which is different depending on the confidentiality level “L1”, “L2”, . . . , or “LG” of the document in the discarding information management database 5, acquires the discarding information 101-1, 101-2, . . . , or 101-n corresponding to the confidentiality level “L1”, “L2, . . . , or “LG” of the read printed document 2a from the discarding information management database 5, displays the discarding information 101-1, 101-2, . . . , or 101-n on a display unit 12, and discards the printed document 2a with the discarding unit 6 according to the discarding information 101-1, 101-2, . . . , or 101-n.

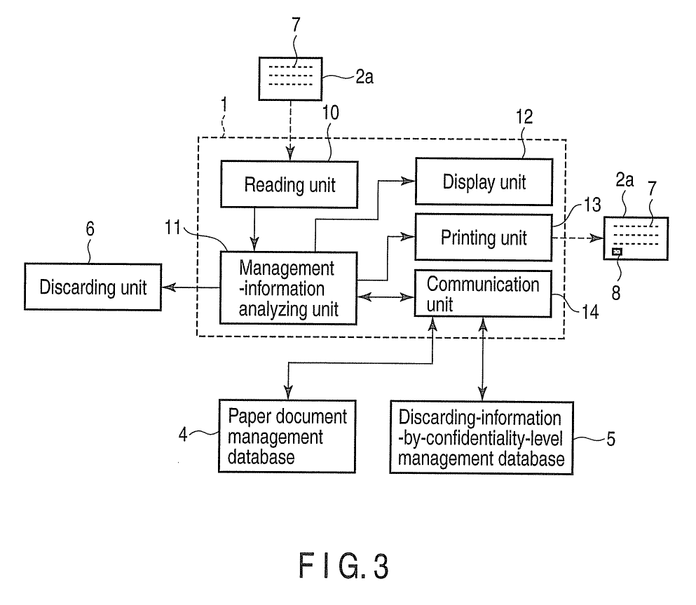

FIG. 3 is a functional block diagram of a document managing system realized by the operation of the controller 1-1. The MFP 1 includes the reading unit 10, a management-information analyzing unit 11, the display unit 12, a printing unit 13, a communication unit 14, the paper document management database 4, the discarding information management database 5, and the discarding unit 6. The reading unit 10, the management-information analyzing unit 11, the display unit 12, the printing unit 13, and the communication unit 14 are provided on the inside of the MFP 1. The paper document management database 4, the discarding information management database 5, and the discarding unit 6 are provided on the outside of the MFP 1.

The reading unit 10 reads a document recorded on the recording medium 2 and acquires a document file.

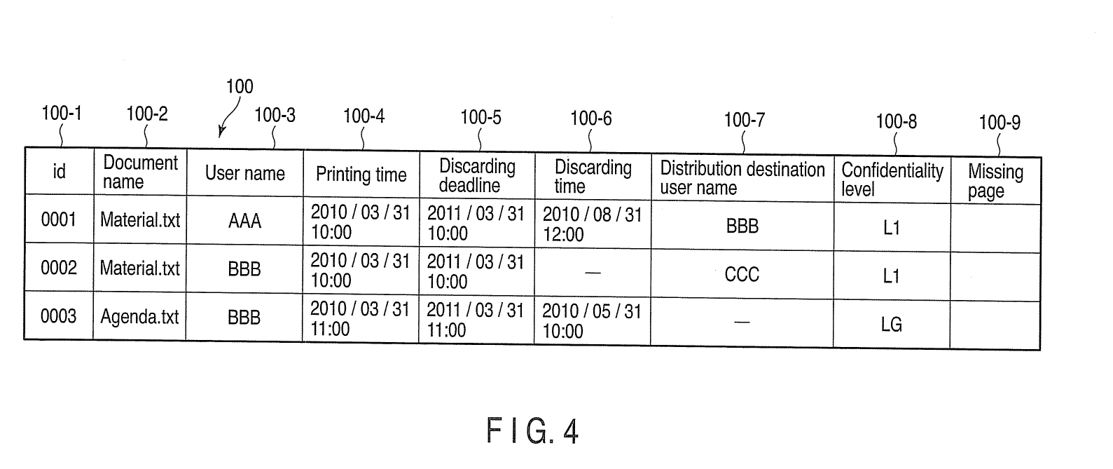

The paper document management database 4 stores document management information 100 including a confidentiality level of the document together with the document file acquired by the reading unit 10. The document management information 100 is managed for each of document files. FIG. 4 is a schematic diagram of the document management information 100. The document management information 100 includes a space 100-1 for a reference number (id), a space 100-2 for a document name, a space 100-3 for a user name, a space 100-4 for printing time, a space 100-5 for a discarding deadline, a space 100-6 for discarding time, a space 100-7 for a distribution destination user name, a space 100-8 for a confidentiality level, and a space 100-9 for a missing page in a document.

In the space 100-1 for a reference number (id), id numbers such as “0001” and “0002” are written. In the space 100-2 for a document name, document names of document files are written. In the space 100-3 for a user name, user names of users who created the document files are written. In the space 100-4 for printing time, times when the document files are printed on the recording media 2 are written. In the space 100-5 for a discarding deadline, years, months, and dates and times of discarding deadlines for the document files are written. In the space 100-6 for discarding time, years, months, and dates and times when the document files are discarded are written. In the space 100-7 for a distribution destination user name, user names at destinations to which the document files are distributed are written. In the space 100-8 for a confidentiality level, confidentiality levels of the document files such as the confidentiality levels “L1”, “L2”, . . . , and “LG” are written. In the space 100-9 for a missing page in a document, missing pages in the documents are written.

In the document management information 100, for example, a space for the number of pages when the document file is printed on the recording media 2 as the printed document 2a and a space indicating a page discarded in the printed document 2a may be added.

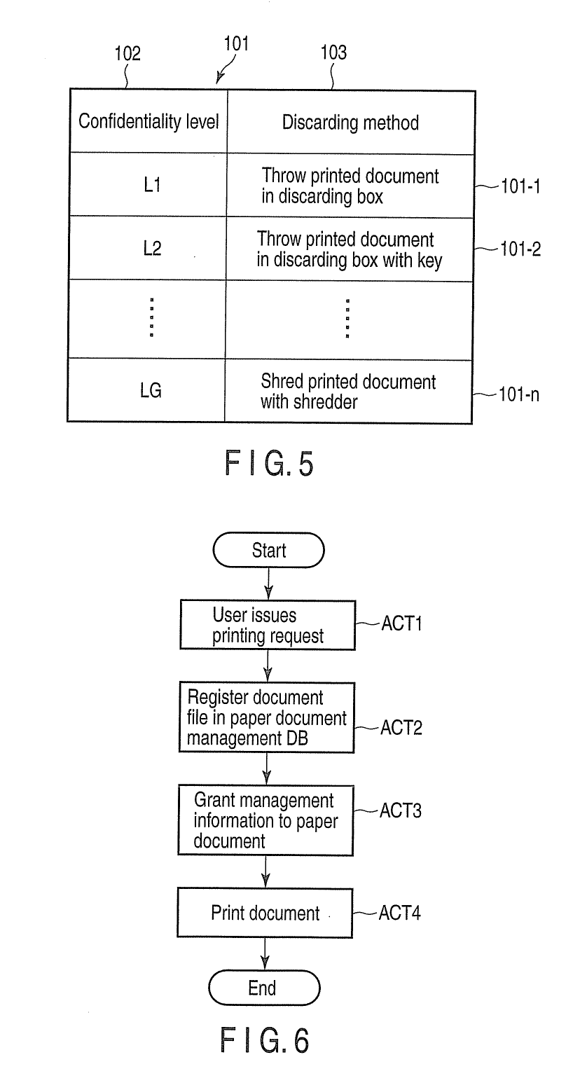

The discarding information management database 5 stores, as shown in FIG. 5, document discarding information 101 for discarding the printed documents 2a each of which is different depending on a confidentiality level of a document. The document discarding information 101 includes plural kinds of discarding information 101-1, 101-2, . . . , and 101-n in which plural discarding methods are described. The document discarding information 101 includes a space 102 for a confidentiality level and a space 103 for a discarding method. In the space 102 for the confidentiality level, for example, the confidentiality levels “L1”, “L2” . . . , and “LG” are written. In the space 103 for a discarding method, for example, plural discarding methods corresponding to the confidentiality levels “L1”, “L2”, . . . , and “LG” are written. The discarding information 101-1 of the lowest confidentiality level “L1” is, for example, “throw the printed document 2a in the discarding box”. The discarding information 101-2 of the confidentiality level “L2” is, for example, “throw the printed document 2a in the discarding box with key”. The discarding information 101-n of the highest confidentiality level “LG” is, for example, “shred the printed document 2a with the shredder”.

The communication unit 14 performs communication of information between the management-information analyzing unit 11 and the paper document management database 4 or the discarding information management database 5. For example, the two personal computers (PCs) 3-1 and 3-2 are connected to the communication unit 14 via the network.

The display unit 12 includes a liquid crystal display. For example, the display unit 12 may emit sound.

The management-information analyzing unit 11 acquires, from the discarding information management database 5, the discarding information 101-1, 101-2, . . . , or 101-n corresponding to the confidentiality level “L1”, “L2”, . . . , or “LG” of the printed document 2a read by the reading unit 10 and displays the discarding information 101-1, 101-2, . . . , or 101-n on the display unit 12.

The discarding unit 6 discards the printed document 2a according to the discarding information 101-1, 101-2, . . . , or 101-n acquired by the management-information analyzing unit 11. The discarding unit 6 includes a discarding box and a shredder. If the discarding information acquired by the management-information analyzing unit 11 is “throw the printed document 2a in the discarding box”, the discarding unit 6 throws the printed document 2a in the discarding box. If the discarding information acquired by the management-information analyzing unit 11 is “shred the printed document 2a with the shredder”, the discarding unit 6 shreds the printed document 2a with the shredder.

The discarding unit 6 is provided on the outside of the MFP 1. The discarding unit 6 includes plural trays corresponding to the plural discarding methods. For example, the trays are trays for the discarding box and the shredder. The MFP 1 sends the printed document 2a to the tray corresponding to each of the discarding methods. Consequently, the printed document 2a is sent to the discarding box or the shredder and discarded.

The management-information analyzing unit 11 causes the discarding unit 6 to discard the printed document 2a and updates the document management information 100 stored in the paper document management database 4.

The management-information analyzing unit 11 analyzes the management information 8 granted to a document and acquires the discarding information 101-1, 101-2, . . . , or 101-n from the discarding information management database 5 according to the confidentiality levels “L1”, “L2”, . . . , or “LG” acquired by the analysis.

The management-information analyzing unit 11 analyzes the management information 8 granted to the document and determines, according to the analysis, whether the document includes a missing page. If the document includes the missing page, the management-information analyzing unit 11 displays indication that the document includes the missing page on the display unit 12. In this case, if the document includes the missing page, the management-information analyzing unit 11 acquires the discarding information 101-1, 101-2, . . . , or 101-n corresponding to the document including the missing page from the discarding information management database 5.

If the management information 8 is not granted to the document, the management-information analyzing unit 11 acquires, from the discarding information management database 5, the discarding information 101-1, 101-2, . . . , or 101-n corresponding to the document not granted with the management information 8.

A printing operation of the MFP 1 configured as explained above is explained below according to a printing operation flowchart of FIG. 6.

A user performs, for example, operation for designation of a document file that the user requests the personal computer 3-1 to print and request for printing of the document file requested to be printed. The personal computer 3-1 transmits, according to operation by the user, the document file requested to be printed and a command for requesting printing of the document file to the MFP 1 via the network (ACT 1). The document file requested to be printed and the command for requesting printing are input to the management-information analyzing unit 11 through the communication unit 14 of the MFP 1.

The management-information analyzing unit 11 registers the document file requested to be printed in the paper document management database 4 shown in FIG. 4 (ACT 2). In the paper document management database 4, a reference number (id) and a document name attached to the document file requested to be printed, a user name of the user who created the document file, printing time, year, month, and date and time of a discarding deadline, a distribution destination user name, the confidentiality level “L1”, “L2”, . . . , or “LG” of the document file, and, if any, a missing page in the document are written.

The management-information analyzing unit 11 grants the management information 8 including the confidentiality level “L1”, “L2”, . . . , or “LG” to the document file requested to be printed (ACT 3). The granting of the management information 8 is performed according to, for example, a policy determined in advance. The management-information analyzing unit 11 may determine the confidentiality level “L1”, “L2”, . . . , or “LG” according to ISMS authentication or the like and grant the management information 8. As the management information 8, for example, the confidentiality level “L1”, “L2”, . . . , or “LG” determined from a result of the ISMS authentication by the management-information analyzing unit 11 may be granted. The management information 8 may be granted by, for example, the operation by the user on an operation unit of the MFP 1.

The management-information analyzing unit 11 sends the document file granted with the management information 8 to the printing unit 13 together with a printing command. The printing unit 13 prints the document on the recording medium 2 and prints the management information 8 of the confidentiality level “L1”, “L2”, . . . , or “LG” on the recording medium 2 (ACT 4).

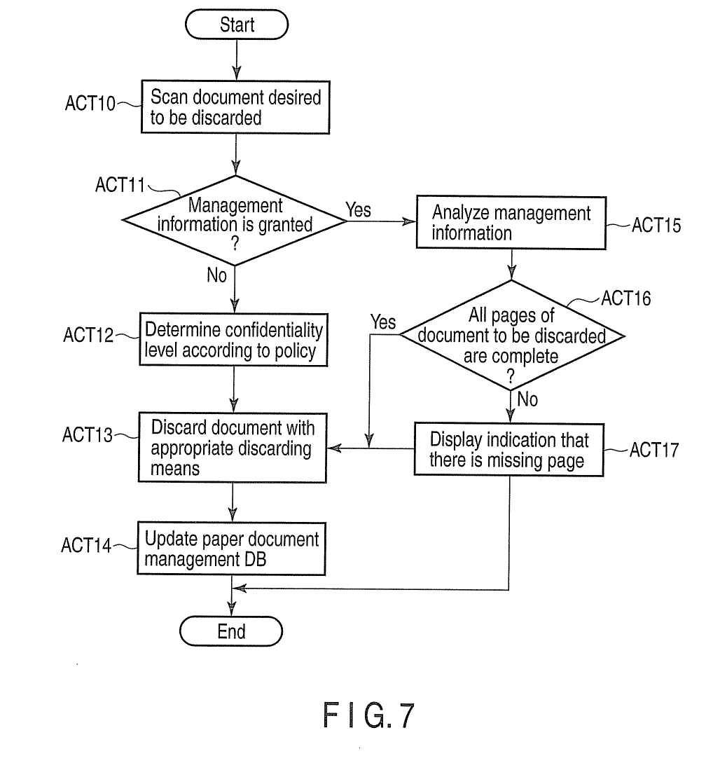

A discarding operation for the printed document 2a by the MFP 1 configured as explained above is explained below according to a discarding operation flowchart of FIG. 7.

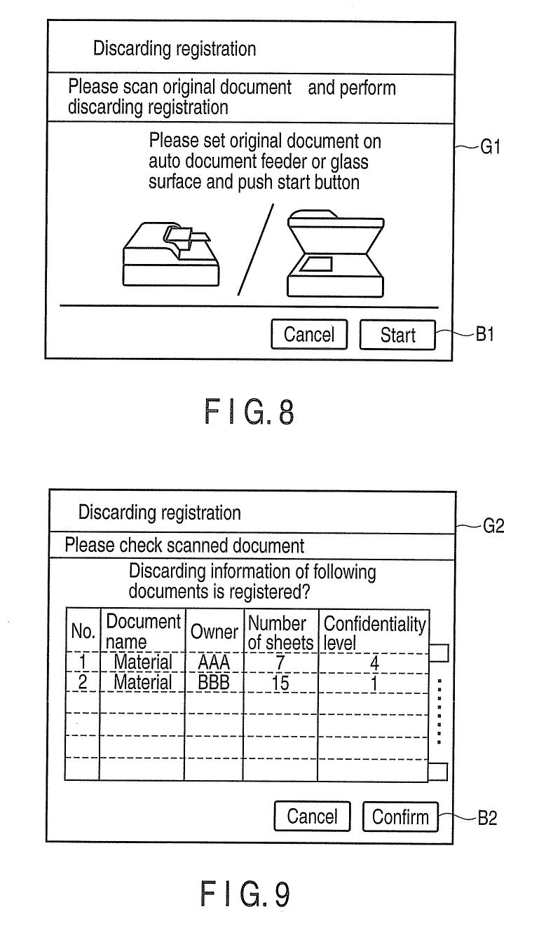

The user sets the printed document 2a requested to be discarded on the MFP 1 and performs operation for performing reading. FIG. 8 is a diagram of an example of a discarding registration screen G1 for registering the printed document 2a requested to be discarded. The discarding registration screen G1 is displayed on the display unit 12 by the management-information analyzing unit 11. When the user touches a start button B1 in the discarding registration screen G1, the reading unit 10 of the MFP 1 scans and reads the printed document 2a requested to be discarded and acquires a document file (ACT 10).

The management-information analyzing unit 11 receives the document file of the printed document 2a acquired by the reading by the reading unit 10 and displays, on the display unit 12, a screen for urging the user to confirm registration of the document file of the printed document 2a. FIG. 9 is a diagram of an example of a registration confirmation screen G2. When the user selects a document name in the registration confirmation screen G2 and touches a confirmation button B2, the management-information analyzing unit 11 registers the printed document 2a having the selected document name.

The management-information analyzing unit 11 determines whether the management information 8 of the confidentiality level “L1”, “L2”, . . . , or “LG” is granted to the document file of the printed document 2a registered to be discarded (ACT 11).

As a result of the determination, if the management information 8 is not granted to the document file, the management-information analyzing unit 11 determines, according to, for example, a policy determined in advance, the management information 8 for the printed document 2a requested to be discarded. The management information 8 may be determined by the operation by the user or may be automatically determined by the management-information analyzing unit 11. The management information 8 of the printed document 2a not granted with the management information 8 is determined as the highest confidentiality level “LG” according to the policy determined in advance.

Therefore, indication that the management information 8 of the printed document 2a not granted with the management information 8 is the highest confidentiality level “LG” is stored in advance in the discarding information management database 5. The management-information analyzing unit 11 reads out, from the discarding information management database 5, the highest confidentiality level “LG” for the printed document 2a not granted with the management information 8 (ACT 12). The discarding information 101-n of the highest confidentiality level “LG” is, for example, “shred the printed document 2a with the shredder”.

A confidentiality level for the printed document 2a not granted with the management information 8 may be the lowest confidentiality level “L1”. The lowest confidentiality level “L1” is “throw the printed document 2a in the discarding box”.

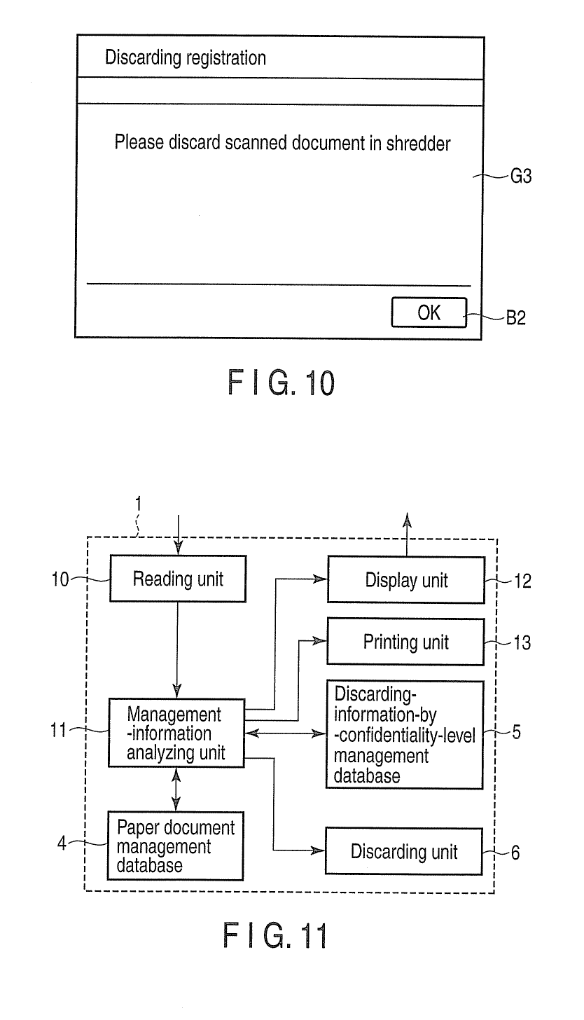

The management-information analyzing unit 11 displays, for example, the highest confidentiality level “LG” for the printed document 2a on the display unit 12. The management-information analyzing unit 11 sends the discarding information 101-n “shred the printed document 2a with the shredder” of the highest confidentiality level “LG” to the display unit 12 and sends the discarding information 101-n to the discarding unit 6. The display unit 12 displays “shred the printed document 2a with the shredder”. FIG. 10 is a diagram of an example of a discarding registration screen G3 displayed on the display unit 12. The discarding registration screen G3 displays “please discard the scanned document in the shredder”.

When the discarding unit 6 receives the discarding information 101-n “shred the printed document 2a with the shredder” of the highest confidentiality level “LG” from the management-information analyzing unit 11, the discarding unit 6 shreds the printed document 2a with the shredder (ACT 13). It is also possible that the user throws the printed document 2a in the shredder as the discarding unit 6 and the shredder shreds the printed document 2a.

The management-information analyzing unit 11 causes the discarding unit 6 to discard the printed document 2a and updates the document management information 100 stored in the paper document management database 4 shown in FIG. 4 (ACT 14). For example, the management-information analyzing unit 11 updates year, month, and date and time of discarding in the document management information 100.

On the other hand, if the management information 8 is granted to the document file, the management-information analyzing unit 11 shifts from ACT 11 to ACT 15 and analyzes the management information 8 granted to the document file. The management-information analyzing unit 11 acquires the confidentiality level “L1”, “L2”, . . . , or “LG” by analyzing the management information 8. The management-information analyzing unit 11 acquires the discarding information 101-1, 101-2, . . . , or 101-n from the discarding information management database 5 shown in FIG. 5 according to the acquired confidentiality level “L1”, “L2”, . . . , or “LG” (ACT 15).

The management-information analyzing unit 11 analyzes the management information 8 granted to the document and determines, according to the analysis, whether the document includes a missing page by analyzing the management information 8 (ACT 16). The management information 8 includes a document name, a user name, and the number of pages of the document. Therefore, the management-information analyzing unit 11 can determine whether there is a missing page in the document file acquired by the reading by the reading unit 10.

As a result of the determination, if there is no missing page in the document and all pages are complete in the document, the management-information analyzing unit 11 shifts to ACT 13 and causes the discarding unit 6 to perform discarding. The discarding unit 6 discards the printed document 2a according to the discarding information 101-1, 101-2, . . . , or 101-n acquired by the management-information analyzing unit 11 (ACT 13). If the discarding information 101-n of the highest confidentiality level “LG” is acquired, the discarding unit 6 shreds the printed document 2a with the shredder. If the discarding information 101-1 of the lowest confidentiality level “L1” is acquired, the discarding unit 6 throws the printed document 2a in the discarding box.

If there is the missing page and not all the pages are complete in the document, the management-information analyzing unit 11 displays, on the display unit 12, indication that the document includes the missing page (ACT 17). The management-information analyzing unit 11 reads out, from the paper document management database 4, only a file of the missing page of the document file acquired by analyzing the management information 8 and displays a file image of the missing page on the display unit 12 as a preview. The management-information analyzing unit 11 prints, with the printing unit 13, the file image of the missing page. When the management-information analyzing unit 11 prints the file image of the missing page, the management-information analyzing unit 11 grants the management information 8 to the file image anew. The management information 8 is set according to the confidentiality level “L1”, “L2”, . . . , and “LG” of a file 7 of the missing page. The management-information analyzing unit 11 acquires, from the discarding information management database 5, the discarding information 101-1, 101-2, . . . , or 101-n corresponding to the document including the missing page. When it is taken into account that the document includes the missing page, for example, the discarding information 101-n of the highest confidentiality level “LG” is acquired.

When the discarding unit 6 receives the discarding information 101-n “shred the printed document 2a with the shredder” of the highest confidentiality level “LG” from the management-information analyzing unit 11, the discarding unit 6 shreds the printed document 2a with the shredder (ACT 13). It is also possible that the user throws the printed document 2a in the shredder as the discarding unit 6 and the shredder shreds the printed document 2a.

The management-information analyzing unit 11 causes the discarding unit 6 to discard the printed document 2a and updates the document management information 100 stored in the paper document management database 4 shown in FIG. 4 (ACT 14). For example, the management-information analyzing unit 11 updates year, month, and date and time of discarding in the document management information 100. The management-information analyzing unit 11 adds information concerning the file of the missing page in the document management information 100 anew.

In this way, the MFP 1 according to the first embodiment causes the reading unit 10 to read the printed document 2a to acquire a document file, stores the management information 8 including the confidentiality level “L1”, “L2”, . . . , or “LG” of the document in the paper document management database 4 together with the document file, acquires the discarding information 101-1, 101-2, . . . , or 101-n corresponding to the confidentiality level “L1”, “L2”, . . . , or “LG” of the read printed document 2a from the discarding information management database 5, displays the discarding information 101-1, 101-2, . . . , or 101-n on the display unit 12, and discards the printed document 2a with the discarding unit 6 according to the discarding information 101-1, 101-2, . . . , or 101-n.

The MFP 1 grants the management information 8 to the printed document 2a, a confidentiality level of which is managed by the ISMS authentication or the like. The management information 8 includes a data code such as a QR code, an IC code, or a barcode and an IC tag. The management information 8 includes a document name, a user name, and the number of pages of the document. The management information 8 includes the confidentiality levels “L1”, “L2”, . . . , or “LG” different for each of the printed documents 2a.

In the paper document management database 4, a document name, a user name, printing time, a discarding deadline, discarding time, and the like of the printed document 2a to be discarded can be managed. The printed document 2a can be surely discarded by a discarding method corresponding to the confidentiality level “L1”, “L2”, . . . , or “LG” determined by the ISMS authentication or the like, for example, a method of throwing the printed document 2a in the discarding box or shredding the printed document 2a with the shredder.

Since it is analyzed whether there is a missing page in the printed document 2a, a discarding method can be surely determined even for the printed document 2a including the missing page. A document name, a user name, printing time, a discarding deadline, discarding time, and the like of the printed document 2a including the missing page can also be managed. The confidentiality level “L1”, “L2”, . . . , or “LG” can also be set for the file 7 of the missing page and a document name, a user name, printing time, a discarding deadline, discarding time, and the like of the document including the missing page can be managed in the paper document management database 4.

If there is the missing page in the document and not all the pages are complete in the document, the management-information analyzing unit 11 displays indication that the document includes the missing page on the display unit 12, displays a file image of the missing page on the display unit 12 as a preview, or prints the file image with the printing unit 13. The user can check the missing page. This can contribute to improvement of convenience for the user.

If there is the missing page, when not only the user who created the document file including the missing page but also another user discards the printed document 2a, the user who creates the document file is informed of the discarding by mail or the like. This can further contribute to improvement of convenience for the user.

The users respectively have the personal computers (PCs) 3-1 and 3-2. The personal computers (PCs) 3-1 to 3-2 are connected to the MFP 1 via the network. Therefore, it is possible to inform the PC 3-1 or 3-2 of the user who does not discard the printed document 2a, a discarding deadline of which comes, to that effect by mail or the like and urge the user to discard the printed document 2a. Discarding of the printed document 2a, a distribution destination user name of which is registered, is performed by a communication mail or the like for urging the user who printed the printed document 2a and the distribution destination user to discard the printed document 2a. Discarding of the printed document 2a, a distribution destination user name of which is not registered is performed by a communication mail or the like for urging the user who printed the printed document 2a to discard the printed document 2a. This makes it possible to surely urge discarding of a paper document.

The personal computers (PCs) 3-1 and 3-2 can respectively read information in the paper document management database 4 from the network through the MFP 1. The users can learn a document name, a user name, printing time, a discarding deadline, discarding time, a distribution destination user name, a confidentiality level, a missing page in the document, and the like by operating the personal computers (PCs) 3-1 and 3-2.

In the first embodiment, the paper document management database 4, the discarding information management database 5, and the discarding unit 6 are provided on the outside of the MFP 1. However, as shown in FIG. 11, the paper document management database 4, the discarding information management database 5, and the discarding unit 6 may be incorporated in the MFP 1.

A second embodiment is explained below with reference to the drawings.

The MFP 1 to which a document managing system according to this embodiment is applied has a configuration same as that shown in FIG. 1. Differences from the first embodiment are explained below.

The management-information analyzing unit 11 does not permit update of the document management information 100 concerning the document including the missing page stored in the paper document management database 4, if a document includes a missing page.

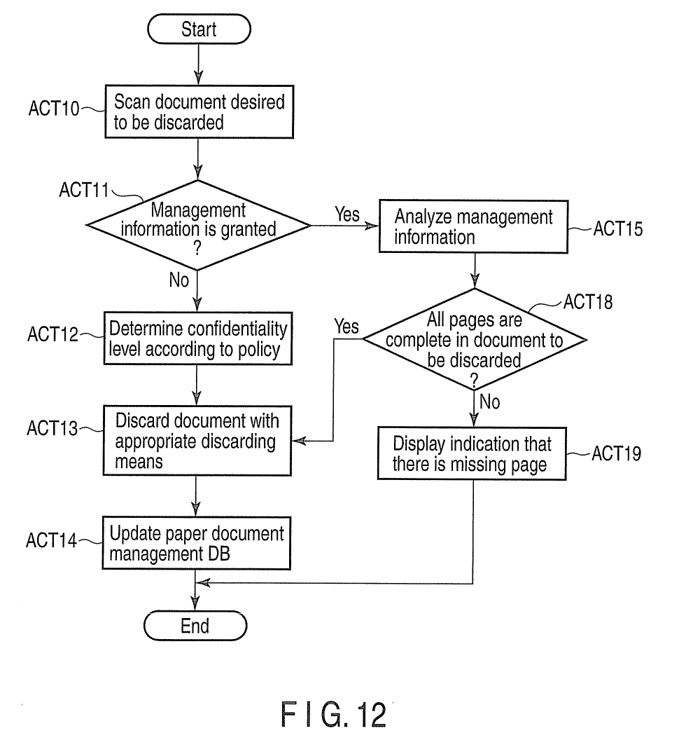

A discarding operation for the printed document 2a by the MFP 1 configured as explained above is explained according to a discarding operation flowchart of FIG. 12.

The management-information analyzing unit 11 analyzes the management information 8 granted to the printed document 2a and determines, according to the analysis, whether a missing page is included in the document (ACT 18).

As a result of the determination, if there is no missing page in the printed document 2a and all pages are complete in the printed document 2a, the management-information analyzing unit 11 shifts to ACT 13 and causes the discarding unit 6 to perform discarding.

If there is the missing page in the document and not all the pages are complete in the printed document 2a, the management-information analyzing unit 11 displays indication that the document includes the missing page on the display unit 12 (ACT 19). The management-information analyzing unit 11 reads out only a file of the missing page of the printed document 2a acquired by analyzing the management information 8 from the paper document management database 4 and displays a file image of the missing page on the display unit 12 as a preview. The management-information analyzing unit 11 prints the file image of the missing page with the printing unit 13.

The management-information analyzing unit 11 ends the processing.

Therefore, if there is the missing page in the printed document 2a, the management-information analyzing unit 11 does not permit update of the document management information 100 concerning the document including the missing page stored in the paper document management database 4. The management-information analyzing unit 11 does not send a command for discarding to the discarding unit 6. Consequently, for example, if there is the missing page in the printed document 2a having a high confidentiality level, the printed document 2a is not discarded in a state in which the page is missing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document managing system comprising:
a communication unit configured to receive, together with a document file obtained by forming a document as a file, document management information including a confidentiality level of the document;
a printing unit configured to add information indicating the confidentiality level to the document file and record the information on a recording medium;
a reading unit configured to read the document recorded on the recording medium;
a document-management-information storing unit configured to store, together with the document file, the document management information including the confidentiality level of the document;
a discarding-information storing unit configured to store plural kinds of discarding information for discarding recording media each of which is different depending on the confidentiality level of the document;
an informing unit; and
a management-information analyzing unit configured to acquire the discarding information corresponding to the confidentiality level of the document read by the reading unit and informing the discarding information from the informing unit.

2. The system according to claim 1, further comprising:
a discarding unit configured to discard the recording medium according to the discarding information acquired by the management-information analyzing unit.

3. The system according to claim 1,
wherein the document-management-information storing unit stores, as the document management information, at least the confidentiality level, a file name of the document file, printing time of the document on the recording medium, discarding time of the recording medium, and information concerning a missing page in the document.

4. The system according to claim 2,
wherein the management-information analyzing unit causes the discarding unit to discard the recording medium and updates the document management information stored in the document-management-information storing unit.

5. The system according to claim 1,
wherein a management information including the confidentiality level is granted to the document.

6. The system according to claim 5,
wherein the management-information analyzing unit analyzes the management information granted to the document and acquires the discarding information from the discarding-information storing unit according to the confidentiality level acquired by the analysis.

7. The system according to claim 5,
wherein the management-information analyzing unit analyzes the management information granted to the document, determines, according to the analysis, whether the document includes a missing page, and informs, if the document includes the missing page, that the document includes the missing page from the informing unit.

8. The system according to claim 7,
wherein the management-information analyzing unit acquires, if the document includes the missing page, the discarding information corresponding to the document including the missing page from the discarding-information storing unit.

9. The system according to claim 7,
wherein the management-information analyzing unit does not permit, if the document includes the missing page, update of the document management information concerning the document including the missing page stored in the document-management-information storing unit.

10. The system according to claim 5,
wherein the management-information analyzing unit acquires, if the management information is not granted to the document, the discarding information corresponding to the document not granted with the management information from the discarding-information storing unit.

11. A document managing method comprising:
receiving, together with a document file obtained by forming a document as a file, document management information including a confidentiality level of the document;
adding information indicating the confidentiality level to the document file and recording the information on a recording medium;
reading the document recorded on the recording medium;
storing, together with the document file, the document management information including the confidentiality level of the document;
storing plural kinds of discarding information for discarding a plurality of the recording media each of which is different depending on the confidentiality level of the document;
acquiring the discarding information corresponding to the confidentiality level of the read document; and
informing the discarding information.

12. The method according to claim 11, further comprising:
discarding the recording medium according to the acquired discarding information.

13. The method according to claim 11, further comprising:
discarding the recording medium and updating the document management information.

14. The method according to claim 11, wherein
a management information including the confidentiality level is granted to the document, and
the method further comprises:
analyzing the management information granted to the document; and
acquiring the discarding information according to the confidentiality level acquired by the analysis.

15. The method according to claim 11, wherein
a management information including the confidentiality level is granted to the document, and
the method further comprises:
analyzing the management information granted to the document;
determining, according to the analysis, whether the document includes a missing page; and
informing, if the document includes the missing page, that the document includes the missing page.

16. The method according to claim 15, further comprising:
acquiring, if the document includes the missing page, the discarding information corresponding to the document including the missing page.

17. The method according to claim 15, further comprising not permitting, if the document includes the missing page, update of the document management information concerning the document including the missing page.

18. The method according to claim 15, further comprising:
acquiring, if the management information is not granted to the document, the discarding information corresponding to the document not granted with the management information.

19. A recording medium having stored thereon a discarding program for a document file readable by a computer, discarding program causing the computer to execute:
receiving, together with a document file obtained by forming a document as a file, document management information including a confidentiality level of the document;
adding information indicating the confidentiality level to the document file and recording the information on a recording medium;
reading the document recorded on the recording medium;
storing, together with the document file, the document management information including the confidentiality level of the document;
storing plural kinds of discarding information for discarding a plurality of the recording media each of which is different depending on the confidentiality level of the document;
acquiring the discarding information corresponding to the confidentiality level of the read document; and
informing the discarding information.

20. The recording medium according to claim 19,
the discarding program further causing the computer to execute discarding the recording medium according to the acquired discarding information.
